(19) United States
(12) Patent Application Publication
(10) Pub. No.: US 2003/0013465 A1
(43) Pub. Date: Jan. 16, 2003

(54) System and method for pseudo-tunneling voice transmissions

(76) Inventors: Philip T. Choong, Los Altos Hills, CA (US); Yuan-Ling Tseng, Mountain View, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/902,158

(22) Filed: Jul. 11, 2001

(51) Int. Cl. H04Q 7/20

(52) U.S. Cl. 455/466; 370/913

(57) ABSTRACT

The present invention comprises a system and method for pseudo-tunneling voice communications over a telecommunications network to preserve the quality of the voice call and reduce degradation due to tandemming loss. The pseudo-tunneling of the present invention comprises processing and routing voice packets as data packets. A voice packet is pseudo-tunneled by setting a pseudo-tunneling flag in the voice packet. The pseudo-tunneling flag provides an indication to network devices that the voice packet should be processed and routed like a data packets. Alternatively, one or more voice packets can be encapsulated in a routing packet for routing across a packet switched data network. The routing packet is pseudo-tunneled by setting a pseudo-tunneling flag in the header of the routing packet. Pseudo-tunneled vocoder frames are not converted into PCM or any other decompressed waveform representation of the voice signal, thereby avoiding tandemming loss and preserving bandwidth.

### FIELD 0F THE INVENTION

The present invention relates generally to the routing of voice and data communications through telecommunication networks. More specifically, the present invention relates to a system and method for pseudo-tunneling voice communications over a telecommunications network to preserve the quality of the voice call and reduce degradation due to tandemming loss.

### BACKGROUND OF THE INVENTION

Improving signal quality and conserving bandwidth are two of the most important goals of telecommunications technology. One of the obstacles to reaching these goals is the heterogeneous telecommunication transmissions network in place that sometimes utilizes antiquated technology. The telecommunications networks in place today include a combination of transmission systems such as analog, digital, optical, and satellite based systems. When a transmission is sent from one of these systems to another, often one or more conversions must take place. For example, to transmit a voice signal from caller A to caller B, the voice signal may have to be decompressed and then converted from digital to analog and later converted back to digital and recompressed. Additional conversions may be needed to convert between different protocols and between different compression standards. These conversions often degrade the quality of the transmitted voice signal, introduce unnecessary protocol conversion processing delays, and increase the bandwidth required to accommodate the call.

This problem can be illustrated by looking at an example of digital cellular telephones connected to a digital mobile communications network such as a Global System for Mobiles (“GSM”) (the standard digital cellular phone service in Europe, Japan, Australia and many other countries) or a Personal Communications Networks/Services (PCN/PCS) (several such networks have been established in North America).

Digital cellular phones connected to these networks typically have built-in “vocoders” for compressing the transmitted digital voice signal. A vocoder is a device for compressing and decompressing a digital speech signal. Instead of transmitting samples of the original speech waveform itself, vocoders compress the speech signal by mapping speech signals onto a mathematical model of the human vocal tract. There are several types of vocoders on the market and in common usage, each having its own set of algorithms associated with the vocoder.

When a digital mobile user A on digital mobile network A places a call to a digital mobile caller B on digital mobile network B, typically multiple conversions of the voice signal are required to transmit the call from user A to user B. For example, assume mobile user A is a PCS user and is placing a long distance phone call to mobile user B on a GSM network. When user A speaks into the mobile phone, the voice signal is digitized by the mobile phone, encoded/compressed by a vocoder and then transmitted to a base station by a radio-frequency (RF) signal. Typically, the vocoded voice signal is between 2.4 kb/s and 13 kb/s.

The base station first decodes/decompresses this bit stream into a PSTN-compatible 64 kb/s PCM (Pulse Coded Modulation) format and forwards the signal to a mobile switching center that determines the route for the voice signal. PCM is the most common method of encoding a voice waveform signal into a digital bit stream. The PCM signal is a digital signal representing the speech waveform.

The PCM voice signal will then typically be routed to the PSTN's Central Office (CO) through landlines. If necessary, the digital signal may have to be converted to analog and later back to digital. Finally the call will be routed from the PSTN to the designation mobile network B and to a base station B servicing mobile user B. The destination base station B must then convert the received PCM signal back to a vocoder digital format compatible with the destination mobile phone B. The vocoded voice signal is then transmitted by a radio frequency (RF) signal to the destination mobile phone B.

Thus, multiple conversions of the voice signal are required to transmit the call from user A to user B. At a minimum, the vocoded call from A must be converted to a waveform representation such as PCM, and then later reencoded by a second vocoder at base station B. Often, the conversion performed at base station A also involves changing the bandwidth of the voice signal to allow the mobile signal to operate on the other network (mobile network B). The effect of all of these conversions is typically to reduce the quality of the voice signal. The loss is referred to as tandemming loss. This problem is exacerbated when multiple non-PSTN networks are utilized to transmit the voice signal. Even when a mobile user places a call to a mobile user on the same network, mobile networks today typically will perform at least one vocoder to PCM conversion and later convert back to a vocoder format. This is especially true when the voice signals are transmitted through a PSTN network, which often is the case.

Another disadvantage is that this method of routing calls is wasteful of bandwidth. The vocoder signal transmitted by the mobile phone has a very compressed format. When the vocoder signal is expanded by converting to PCM, the resulting PCM signal requires significantly more bandwidth to transmit than the original compressed vocoder signal.

Thus, there is a need for a method of transmitting compressed voice signals through today's communications networks that preserves voice quality and the integrity of the original signal and avoids tandemming loss. Furthermore, there is a need for a method of routing calls that does not waste bandwidth. As telecommunications networks continue to expand, efficient use of bandwidth is always very important because the less bandwidth that is used, the greater the amount of information that may be sent.

Today, the public switched telephone network (PSTN) is the de facto backbone for routing calls between telecommunications network. In other words, when placing a call from a caller A to caller B, often the call will be routed through the PSTN. However, routing a call through the PSTN often requires converting the call to a waveform representation such as PCM. Thus, what is also needed is a system and method for routing information that minimizes the use of the PSTN as the de facto backbone.

### SUMMARY OF THE INVENTION

The present invention relates to a system and method for pseudo-tunneling voice communications over a telecommunications network to preserve the quality of the voice call and reduce degradation due to tandemming loss. The “pseudo-tunneling” of the present invention comprises processing and routing voice packets as data packets. A voice packet is pseudo-tunneled by setting a pseudo-tunneling flag in the voice packet. The pseudo-tunneling flag provides an indication to network devices that the voice packet should be processed and routed like a data packets. Alternatively, one or more voice packets can be encapsulated in a routing packet for routing across a packet switched data network. The routing packet is pseudo-tunneled by setting a pseudo-tunneling flag in the header of the routing packet.

According to the system of the present invention, voice packets transmitted from a user terminal such as a cellular telephone are received at a local interface. Each voice packet includes one or more vocoder frames of a first vocoder format. The vocoder frames are not converted into PCM or other decompressed waveform representation of the speech signal. Instead, the local interface sets a pseudo-tunneling flag in each received voice packet. The voice packets are then forwarded to a network switch.

The network switch normally routes voice calls through a public switched telephone network (PSTN) and routes data calls through a packet switched data network. However, if the network switch receives a voice packet having a pseudo-tunneling flag which is set, the network switch will treat the voice packet as data and route the voice packet through the packet switched data network rather than through the PSTN.

When voice packets are received by a destination local interface, the destination local interface will check the pseudo-tunneling flag in each voice packet. If the pseudo-tunneling flag is set, then the destination local interface will process the packet as a pseudo-tunneled voice packet. One method of processing the pseudo-tunneled voice call is to convert the included vocoder frames from a first vocoder format to a second vocoder format. Preferably, this is performed by a compressed domain transcoder.

A pseudo-tunneled voice call can also be routed through a packet-switched data network using a switched virtual circuit (SVC). An SVC is a virtual circuit connection established across the packet switched data network on an as-needed basis and lasting only for the duration of the call. When the last packet is received at the final destination, the pseudo-tunnel in the form of the SVC is automatically destroyed. The specific path provided in support of the SVC is determined on a call-by-call basis and in consideration of both the end points and the level of congestion in the network. The use of a SVC will provide QoS (Quality of Service) comparable to the QoS commonly expected in the circuit-switched PSTN system.

When an SVC is being used, a pseudo-tunnel is established during the call set-up/signaling process. The “pseudo-tunnel” is the virtual circuit from the caller to the destination. Voice packets will then travel through the pseudo-tunnel until the end of the call. At the end of the call, the SVC is automatically torn-down. The present invention can also be implemented on a system that does not route data calls and voice calls separately over different networks. In this embodiment, where a data packet switched network is not available, the vocoder bits may need to be padded with a special bit sequence to increase the size of the vocoder packets to 64 kilobits/sec PCM bit rate for routing over a PSTN.

The pseudo-tunneling system and method of the present invention provides several advantages. First, it improves the quality of the received voice signal because it eliminates the tandemming loss. There is no conversion to PCM or any other waveform representation of the voice signal. Secondly, it saves bandwidth because the compressed vocoder packets are transmitted all the way through the system, rather than decompressing the vocoder signal and transmitting the decompressed voice signal through the system as a 64 kilobit/sec PCM signal. Third, it reduces computing resources and processing delays caused by the unnecessary conversions of the tandem connection.

### BRIEF DESCRIPTION OF THE DRAWINGS

FIG. 1 depicts a block diagram illustrating a conventional telecommunications network for routing voice and data communications.

FIG. 2 depicts a block diagram illustrating a tandem connection.

FIG. 3 depicts a block diagram illustrating a telecommunications network for processing pseudo-tunneled voice calls with compressed domain transcoders.

FIG. 4 depicts a block diagram illustrating an embodiment in which voice calls and data calls are routed over the same network.

FIG. 5 depicts a block diagram illustrating a Global System for Mobile (GSM) Communications network

### DETAILED DESCRIPTION OF THE INVENTION

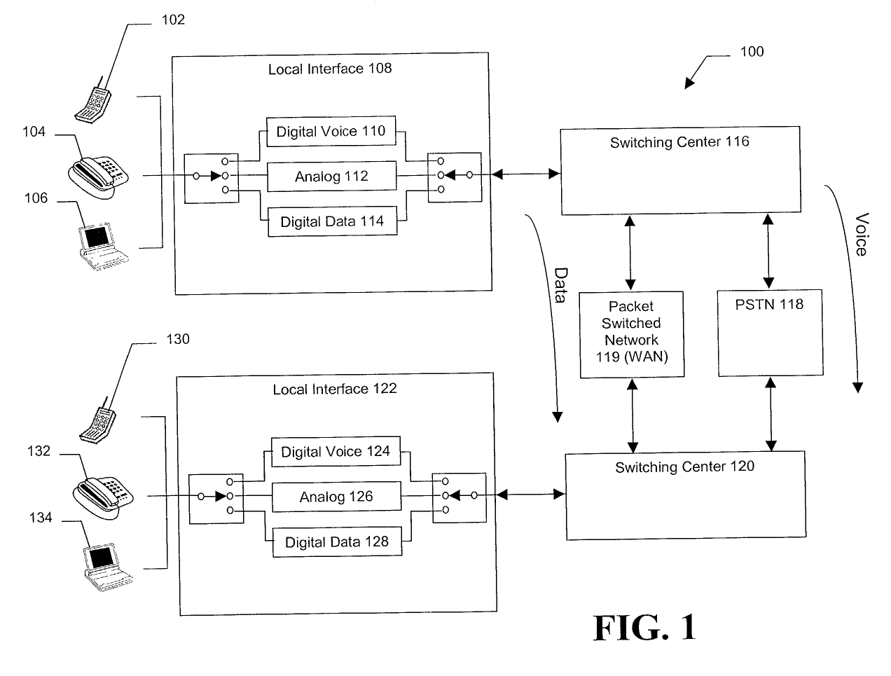

FIG. 1 depicts a block diagram illustrating an example of a generalized telecommunications network 100. Telecommunications network 100 is able to route a variety of different types of calls containing either voice or data between devices such as fixed telephones, mobile telephones, computers, and facsimiles. For example, a call can be placed by a calling party from digital cellular telephone 102, analog telephone 104, or computer laptop terminal 106.

During the set-up of the call with local interface 108, the local interface 108 determines whether the call is a digital voice call (e.g. from digital cellular telephone 102), an analog call (e.g. from analog telephone 104), or a digital data call (e.g. from computer laptop terminal 106). A digital voice call is processed by digital voice processing unit 110. An analog call is processed by analog processing unit 112. A digital data call is processed by digital data processing unit 114.

After processing, Local Interface 108 transmits the call to a switching center 116. If the call is a voice call, switching center 116 routes the call through the public switched telephone network (PSTN). If the call is a data call, switching center 116 routes the data call through a packet switched network 119 (e.g. the Internet). PSTN 118 is a public network that carries voice calls. The most common backbone transmission medium within the PSTN is an optical fiber that carries a large number of voice circuits each of which carries a 64 kilobit/sec PCM signal.

The call, whether voice or data, is ultimately routed to a destination switching center 120. Destination switching center 120 routes the call to a local interface 122 on the destination side. If the call is a digital voice call, the call is processed by digital voice processing unit 124. An analog call is processed by analog processing unit 126. A digital data call is processed by digital data unit 128. After the call is processed, it is transmitted to the destination terminal, e.g. digital cellular telephone 130, analog telephone 132, or laptop computer terminal 134.

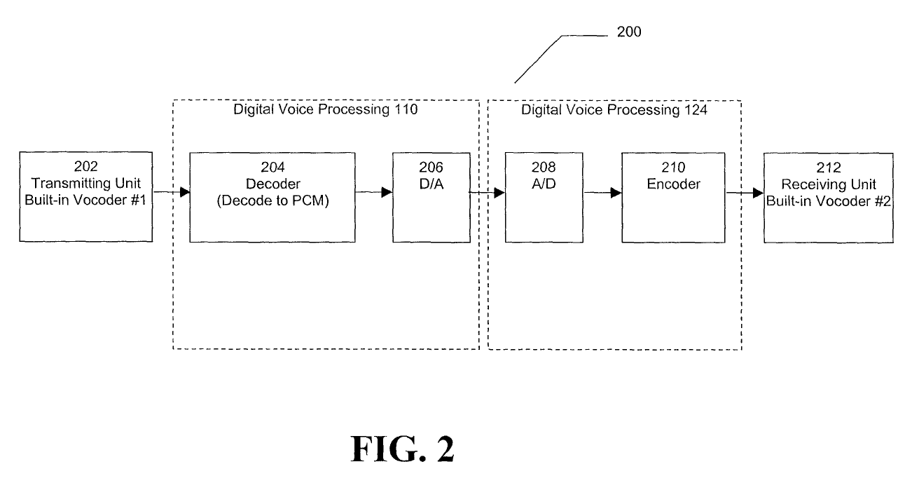

A digital voice call between digital cellular phone 102 and digital cellular phone 130 will be processed by digital voice processing unit 110 (in local interface 108) and digital voice processing unit 124 (in local interface 122). This digital voice processing will introduce some degradation in the quality of the speech signal due to tandemming loss. This will now be explained with respect to FIG. 2.

FIG. 2 shows a transmitting unit 202. This transmitting unit could be, for example, the digital cellular phone 102 illustrated in FIG. 1. Transmitting unit has a built-in vocoder that encodes the speech according to a vocoder standard which we will refer to as vocoder #1. There are several different types of vocoder standards. Some of the most modern low bit-rate standards include LPC-10 (Linear Prediction Coding, a federal standard, having a transmission rate of 2.4 kilobits/sec), MELP (Mixed Excitation Linear Prediction, another federal standard, also having a transmission rate of 2.4 kilobits/sec), and TDVC (Time Domain Voicing Cutoff, a high quality, ultra low rate speech coding algorithm developed by General Electric and Lockheed Martin having a transmission rate of 1.75 kilobits/sec).

Transmitting unit 202 transmits the voice call in the form of vocoder parameters to local interface 108 (shown in FIG. 1). The digital voice call is processed by digital voice processing unit 110. First, the vocoder parameters are decoded to PCM by decoder 204. The PCM signal is a digital waveform representation of the speech signal. Note that the conversion to PCM has the effect of decompressing the signal and increasing the bandwidth required to accommodate the call.

For example, for low bit rate vocoders, the compressed vocoder signal received from transmitting unit 202 is transmitted at a rate of approximately 1.75-2.4 kilobits/sec (depending on the particular vocoder standard begin used). After the signal has been decoded to PCM by decoder 204, the same signal is expanded to 64 kilobits/sec thereby greatly increasing the bandwidth necessary to accommodate the digital voice call.

After decoding the voice signal by decoder 204, the digital PCM signal is converted to analog by digital-to-analog (D/A) converter 206. Referring to FIG. 1, the analog voice signal is then transmitted to switching center 116. Note that this assumes that the connection between local interface 108 and switching center 116 is an analog connection. If it is a digital connection, then D/A converter 206 is not necessary. In this case, the digital PCM signal is transmitted directly to switching center 116.

The digital voice call is then routed through PSTN 118, switching center 120, and over to local interface 122, where it is processed by digital voice processing unit 124. Digital voice processing unit 124 converts the analog voice signal to digital PCM using analog-to-digital (A/D) converter 208. The digital PCM signal is then encoded to a vocoder #2 standard by encoder 210. Finally, the voice signal encoded according to vocoder #2 standard is transmitted to receiving unit 212. Receiving unit 212 could be, for example, a digital cellular phone such as digital cellular phone 130 shown in FIG. 1. Receiving unit 212 has a built-in vocoder #2 which decodes the received vocoder signal. Note that the vocoder #2 standard may be the same or different from the vocoder #1 standard used by the transmitting unit 202.

This type of connection illustrated in FIG. 2 is called a “tandem” connection; i.e. the compressed vocoder signal is decoded to a waveform representation such as PCM for transmission, and then reencoded as a vocoder signal when it reaches its destination. The problem with a tandem connection is that it uses significant computing resources and usually results in a significant loss of both subjective and objective speech quality. This is referred to as “tandemming” loss.

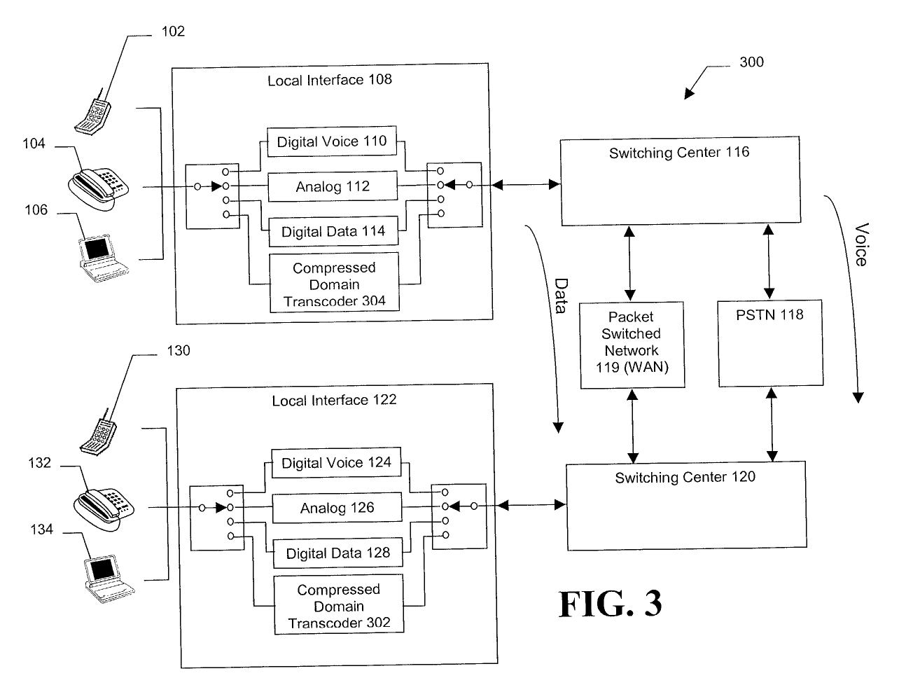

The present invention overcomes these problems by a method which will be referred to herein as “pseudo-tunneling,” described as follows. Referring to FIG. 3, a user places a call with digital cellular phone 102. During the signaling process, local interface 108 establishes that the call is a digital voice call and will be processed by digital voice processing unit 110. Digital voice processing unit 110 receives the digital voice signal from digital cellular phone 102. The digital voice signal consists of voice packets, each voice packet containing one or more vocoder frames.

According to the present invention, digital voice processing unit 110 no longer converts the vocoder frames into PCM or other waveform representation of the speech signal. Instead, digital voice processing unit 110 merely sets a “pseudo-tunneling flag” in each received voice packet. The pseudo-tunneling flag is simply one or more previously unused or reserved bits in each voice packet. The purpose of the pseudo-tunneling flag is to provide an indication that the voice packet should not be treated like a voice communication, but instead should be treated like a data packet. In other words, whenever any network device receives the voice packet, the network device will check the pseudo-tunneling flag in the voice packet. If the pseudo-tunneling flag is set, the network device will treat the voice packet as a data packet rather than a voice signal.

For example, normally switching center 116 will route voice calls through PSTN 118 and route data calls through packet switched network 119. However, if switching center 116 receives a voice packet having a pseudo-tunneling flag which is set, switching center 116 will treat the voice packet as data and route the voice packet through packet switched network 119 rather than through PSTN 118.

When voice packets are received by destination local interface 122, local interface 122 will check the pseudo-tunneling flag. If the pseudo-tunneling flag is set, then local interface 122 will recognize that the voice packets contain vocoder frames. Referring to FIG. 3, if the pseudo-tunneling flag is set, local interface 122 processes the vocoder packets using compressed domain transcoder 302.

Compressed domain transcoder 302 is a device which converts vocoder packets from a first vocoder standard to a second vocoder standard (e.g. LPC packets are converted to MELP packets) directly in the compressed domain, without decompressing the packets to a waveform representation. In other words, the vocoder packets are converted without converting the packets to a PCM or other waveform representation. This preserves the quality of the speech signal by avoiding the tandemming loss. A compressed domain transcoder is described in detail in copending U.S. patent application Ser. No. ______, “Compressed Domain Universal Transcoder.”

Compressed Domain Transcoder 302 therefore transforms the incoming vocoder frames into vocoder frames compatible with the built-in vocoder used by receiving cellular phone 130. In summary, a voice call is placed by digital cellular phone 102. Instead of converting the digital voice call to PCM and routing the call as a voice call, local interface 108 sets a pseudo-tunneling flag in each of the voice packets. The pseudo-tunneling flag provides an indication that the voice packets should be routed as data packets. The voice packets are thus routed through packet switched network 119 by switching center 116. At the destination local interface, the vocoder frames are converted to a different vocoder standard (compatible with the built-in vocoder used by the destination cellular phone 130) by compressed domain transcoder 302. Finally, the converted vocoder frames are transmitted to the destination cellular phone 130.

The pseudo-tunneling method just described provides the following advantages. First, it improves the quality of the received voice signal because it eliminates the tandemming loss. There is no conversion to PCM or any other waveform representation of the voice signal. Secondly, it saves bandwidth because the compressed vocoder packets are transmitted all the way through the system, rather than decompressing the vocoder signal and transmitting the decompressed voice signal through the system as a 64 kilobit/sec PCM signal. Third, it reduces computing resources and processing delays caused by the unnecessary conversions of the tandem connection.

Referring to FIG. 3, the pseudo-tunneled voice call can also be routed through the packet-switched data network 119 using a switched virtual circuit (SVC), if the packet switched data network 119 supports this capability. For example, frame relay networks support SVC capability. An SVC is a virtual circuit connection established across a packet switched network on an as-needed basis and lasting only for the duration of the call. When the last packet is received at the final destination, the pseudo-tunnel in the form of the SVC is automatically destroyed. The specific path provided in support of the SVC is determined on a call-by-call basis and in consideration of both the end points and the level of congestion in the network. The use of a SVC will provide QoS (Quality of Service) comparable to the QoS commonly expected in the circuit-switched PSTN system.

When an SVC is being used, a pseudo-tunnel is established during the call set-up/signaling process. The “pseudo-tunnel” is the virtual circuit from the caller to the destination. Voice packets will then travel through the pseudo-tunnel until the end of the call. At the end of the call, the SVC is automatically torn-down.

FIG. 3 illustrates that compressed domain transcoder 302 is located in local interface 122. It is also possible that the compressed domain transcoder 302 is located instead within the receiving unit 130. In other words, the function of converting the packets from vocoder #1 standard to vocoder #2 standard could be performed within the receiving unit 130 instead of the local interface 122. It is also possible that function of setting of the pseudo-tunneling flag in the vocoder packets could be performed in the transmitting cellular phone 102, rather than by digital voice processing unit 110.

As mentioned before, the pseudo-tunneling flag is one or more bits in each vocoder packet. As an alternative embodiment, local interface 108 could further encapsulate one or more voice packets into another data packet suitable for routing through packet switched data network 119. For example, multiple voice packets could be encapsulated into a single TCP/IP packet by digital voice processing unit 110. The pseudo-tunneling flag would then be located in the header of the TCP/IP packet.

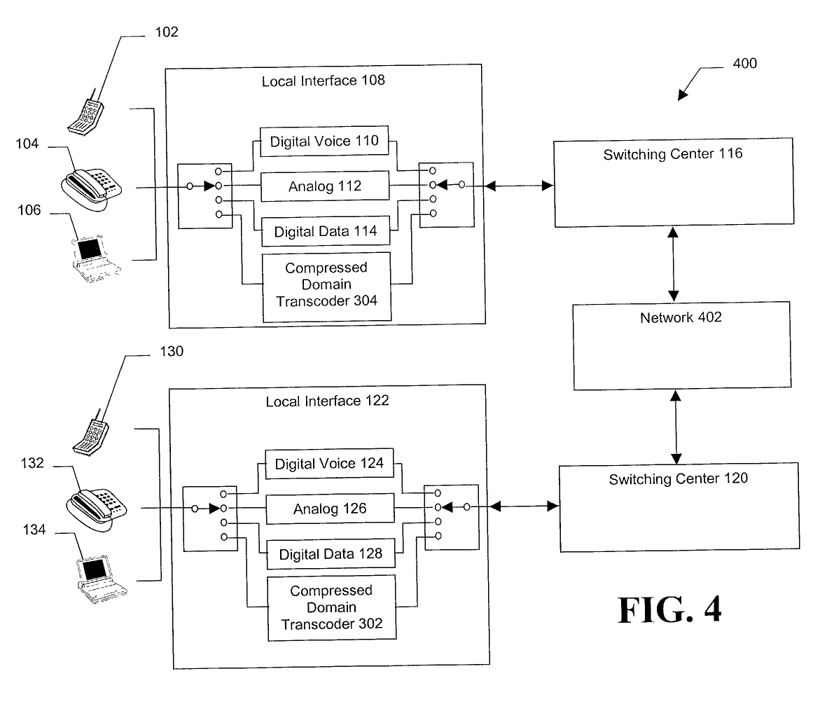

The present invention can also be implemented on a system that does not route data calls and voice calls separately over different networks. FIG. 4 illustrates this alternative embodiment. In this system 400, both data and voice are routed over the same network 402. Network 402 could be a circuit switched network such as the PSTN. In this embodiment, where a data packet switched network is not available, digital voice processing unit 110 may need to pad the vocoder bits with a special bit sequence to increase the size of the vocoder packets to 64 kilobits/sec PCM bit rate (assuming that network 402 is the PSTN—the most common backbone transmission medium within the PSTN is an optical fiber that carries a large number of voice circuits each of which carries a 64 kilobit/sec PCM signal). The padded vocoder bits are then routed through the circuit-switched network 402. At the destination local interface 122, the padded bits are removed to recover the original vocoder bits. The vocoder bits are processed by the compressed domain transcoder 302 and transmitted to the mobile user 130.

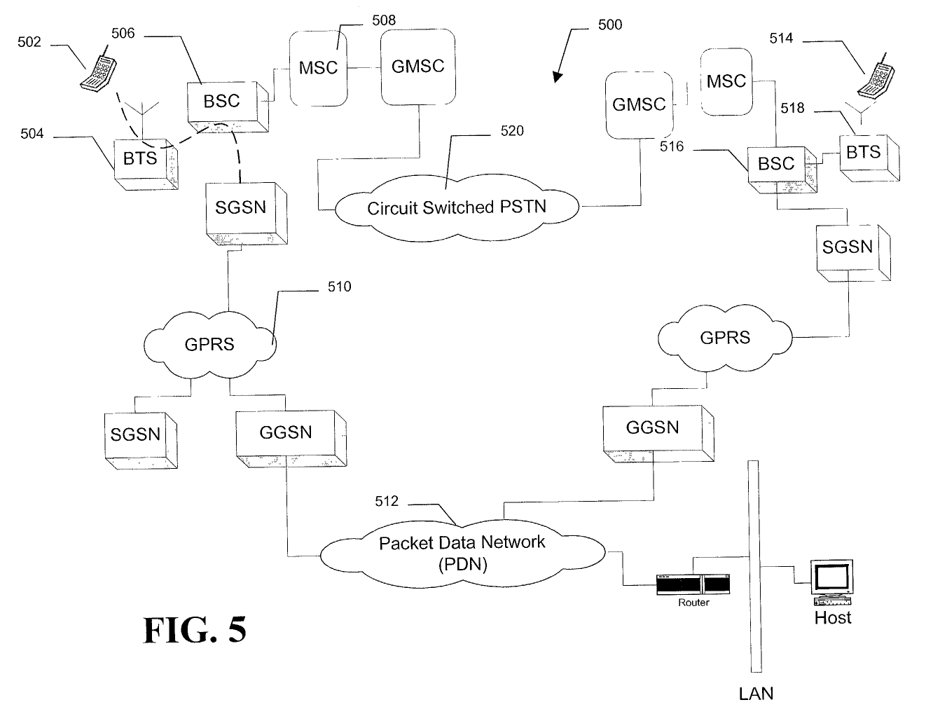

The pseudo-tunneling method of the present invention can be implemented on a variety of different types of telecommunications networks. For example, FIG. 5 depicts a block diagram illustrating a Global System for Mobile (GSM) Communications network. It is the standard digital cellular phone service in Europe, Japan, Australia, and elsewhere,—a total of 85 countries around the world. GPRS is the data service for GSM, the European standard digital cellular service.

A digital cellular telephone 502 places a digital call to digital cellular telephone 514. The call from digital cellular telephone 502 is received at Base Transceiver Station (BTS) 504 over an RF interface. Vocoder packets are transmitted from digital cellular telephone 502 to BTS 504 using RF communications. The call is routed to a Base Station Controller (BSC) 506. BSC 506 is a device that manages radio resources in GSM, including the BTS 504, for specified cells within the Public Land Mobile Network (PLMN).

In a conventional system, BSC 506 routes digital voice calls to mobile switching center (MSC) 508 for routing over the PSTN 520, whereas BSC 506 routes digital data calls to General Packet Radio Service (GPRS) 510 for routing over packet data network 512. GPRS 510 is the packet-switched data service for GSM.

When pseudo-tunneling according to the present invention is implemented on the GSM network shown in FIG. 5, BTS 504 will set the pseudo-tunneling flag in the voice packets received from cellular telephone 502. This function could also be performed by BSC 506 or cellular telephone 502 itself. BSC 506 will therefore treat these packets as data packets which will be routed to GPRS 510. If the network supports SVC capability, an SVC can be set up through the packet data network 512 which will last for the duration of the call. The vocoder packets will be routed to the destination cellular telephone 514. At some point, the vocoder packets will be converted by a compressed domain transcoder. For example, transcoding can occur in BSC 516, BTS 518, or in cellular telephone 514 itself.

An explanation of the term “pseudo-tunneling” will now be provided. In conventional network terminology, “tunneling” generally refers to the process of placing an entire packet within another packet (i.e. encapsulation) and sending it over a network. The protocol of the outer packet is understood by the network and both points, called tunnel interfaces, where the packet enters and exits the network. For example, an Ethernet data packet on an Ethernet network can be encapsulated in an IP packet for transmission across an IP network, such as the Internet. The IP packet could be transmitted across the Internet to a destination Ethernet network. When the IP packet reaches the destination tunnel interface, the outer encapsulating IP packet is stripped, leaving the underlying Ethernet packet. In this example, the tunneling therefore allows a source Ethernet network to send an Ethernet packet across an IP network (the Internet) to a destination Ethernet network.

The “pseudo-tunneling” of the present invention is similar to conventional tunneling, in that pseudo-tunneling allows one type of packet (i.e. a voice packet) to be routed over a network supporting a second type of packet (i.e. a packet switched network supporting data packets). The difference is that the pseudo-tunneling of the present invention does not require the voice packets to be encapsulated. The voice packets merely contain a pseudo-tunneling flag which communicates to network devices that the voice packet should be routed like data packets. However, as mentioned previously, the voice packets could be encapsulated in another packet, if desired. In this case, the outer packet would contain a pseudo-tunneling flag.

Although specific embodiments of the present invention have been described, it will be understood by those of skill in the art that there are other embodiments that are equivalent to the described embodiments. Accordingly it is to be understood that the invention is not to be limited by the specific illustrated embodiments, but only be the scope of the appended claims.

1. A method of routing a bit stream representing a voice communication over a telecommunications network, comprising:
receiving a bit stream representing a voice communication;
setting at least one bit in the bit stream as a pseudo-tunneling flag;
receiving the bit stream at a network switch;
checking the pseudo-tunneling flag of the bit stream; and
processing the bit stream as a data communication rather than a voice communication if the pseudo-tunneling flag is set.

2. The method of claim 1, further comprising:
receiving a call at a local interface;
determining during a call setup process whether the call is a voice call; and
setting a pseudo-tunneling flag in a bit stream of the call if the call is a voice call.

3. The method of claim 1, wherein the bit stream represents voice packets, each voice packet including at least one vocoder frame of a first vocoder format.

4. The method of claim 3, wherein the bit stream is not converted from the first vocoder format to a decompressed format.

5. The method of claim 3, further comprising:
setting at least one bit in each voice packet as pseudo-tunneling flag.

6. The method of claim 3, further comprising:
encapsulating at least one vocoder packet into a routing packet for routing through a packet switched data network.

7. The method of claim 1, wherein the step of processing the bit stream comprises routing voice calls through a public switched telephone network if a pseudo-tunneling flag is not set, and routing voice calls through a data network if the pseudo-tunneling flag is set.

8. The method of claim 1, further comprising:
receiving the bit stream at a destination local interface;
checking at least one pseudo-tunneling flag of the bit stream; and
processing the bit stream as a pseudo-tunneled bit stream if the pseudo-tunneling flag is set.

9. The method of claim 8, wherein a pseudo-tunneled bit stream is processed by a transcoder which converts the bit stream into a second vocoder format.

10. The method of claim 9, wherein the transcoder is a compressed domain transcoder.

11. The method of claim 10, wherein the compressed domain transcoder converts one of the following vocodor formats: LPC, TDVC, and MELP.

12. The method of claim 1, wherein a pseudo-tunneled voice call is routed through a packet-switched data network using a switched virtual circuit (SVC).

13. The method of claim 12, wherein the SVC lasts only for the duration of the call and is torn down at the completion of the call.

14. The method of claim 1, wherein voice calls and data calls are routed over the same network.

15. The method of claim 14, further comprising padding the bit stream with a padded bit sequence accommodate routing the bit stream across a network.

16. A method of routing a bit stream representing a voice communication over a telecommunications network, comprising:
receiving a bit stream;
checking a pseudo-tunneling flag of the bit stream; and
processing the bit stream as a data communication rather than a voice communication if the pseudo-tunneling flag is set.

17. The method of claim 16, further comprising:
receiving a call at a local interface;
determining during a call setup process whether the call is a voice call; and
setting a pseudo-tunneling flag in a bit stream of the call if the call is a voice call.

18. The method of claim 16, wherein the bit stream represents voice packets, each voice packet including at least one vocoder frame of a first vocoder format.

19. The method of claim 18, wherein the bit stream is not converted from the first vocoder format to a decompressed format.

20. The method of claim 18, further comprising:
setting at least one bit in each voice packet as pseudo-tunneling flag.

21. The method of claim 18, further comprising:
encapsulating at least one vocoder packet into a routing packet for routing through a packet switched data network; and
setting a pseudo-tunneling flag in the routing packet.

22. The method of claim 16, wherein the step of processing the bit stream comprises routing voice calls through a public switched telephone network if a pseudo-tunneling flag is not set, and routing voice calls through a data network if the pseudo-tunneling flag is set.

23. The method of claim 16, further comprising:
receiving the bit stream at a destination local interface;
checking at least one pseudo-tunneling flag of the bit stream;
processing the bit stream as a pseudo-tunneled bit stream if the pseudo-tunneling flag is set.

24. The method of claim 23, wherein a pseudo-tunneled bit stream is processed by a transcoder which converts the bit stream into a second vocoder format.

25. The method of claim 24, wherein the transcoder is a compressed domain transcoder.

26. The method of claim 16, wherein a pseudo-tunneled voice call is routed through a packet-switched data network using a switched virtual circuit (SVC).

27. The method of claim 26, wherein the SVC lasts only for the duration of the call and is torn down at the completion of the call.

28. The method of claim 16, wherein voice calls and data calls are routed over the same network.

29. The method of claim 28, further comprising padding the bit stream with a padded bit sequence accommodate routing the bit stream across a network.

30. A system for routing a bit stream representing a voice communication over a telecommunications network, comprising:
a source local interface receiving a bit stream representing a voice communication and setting at least one pseudo-tunneling flag in the bit stream;
a network switch receiving the bit stream from the source local interface and processing the bit stream as a data communication if the pseudo-tunneling flag is set.

31. The system of claim 30, wherein the network switch routes the bit stream over a public switched telephone network if the pseudo-tunneling flag is not set, and routes the bit stream over a data network if the pseudo-tunneling flag is set.

32. The system of claim 31, further comprising:
a destination local interface receiving the bit stream from the network switch; transcoding the bit stream if the pseudo-tunneling flag is set.
